(19) United States
(12) Patent Application Publication
(10) Pub. No.: US 2026/0287021 A1
(43) Pub. Date: Sep. 24, 2026

(54) BEARING SYSTEM INCLUDING A GROUNDING BRUSH ASSEMBLY AND ASSOCIATED ASSEMBLY

(71) Applicants: AKTIEBOLAGET SKF, GOTEBORG (SE); SKF Aerospace France S.A.S, Perrigny (FR)

(72) Inventors: Benoit ARNAULT, Saint-Cyr-sur-Loire (FR); Franck GERVAIS, Bourg de Péage (FR)

(21) Appl. No.: 19/564,528

(22) Filed: Mar. 12, 2026

(30) Foreign Application Priority Data
Mar. 21, 2025 (FR) 2502893FR

(51) Int. Cl. F16C 41/00; H02K 11/40

(52) U.S. Cl. CPC F16C 41/002; H02K 11/40; F16C 2380/26

(57) ABSTRACT

A bearing system includes a bearing provided with an inner race and an outer race, and a grounding brush assembly including a brush which is offset axially outwardly with respect to the inner race of the bearing and provided with a plurality of conductive fibers and with a support inside which the conductive fibers are mounted. The grounding brush assembly further includes a brush mounting plate, which is fixed to the support of the brush and has a mounting portion arranged partly inside a groove formed in a bore of the outer race of the bearing.

### CROSS-REFERENCE

This application claims priority to French patent application no. 2502893 filed on Mar. 21, 2025, the contents of which are fully incorporated herein by reference.

### BACKGROUND OF THE INVENTION

The present invention relates to the general field of grounding devices for controlling the shaft current generated in electric motors or electrical machines, and in particular to grounding brush assemblies.

In an electric motor or an electrical machine, at least one rolling bearing is mounted between the housing of the electric motor or of the electrical machine and the rotary shaft in order to support this shaft.

During operation, when the shaft is in rotation, an electrical potential difference may occur between the latter and the housing of the electric motor or of the electrical machine, which generates an electric current between the inner race of the rolling bearing, which is fixed to the shaft, and the outer race which is fixed to the housing.

By flowing through the components of the rolling bearing, the electric current may damage these components, in particular the rolling elements and the rolling tracks formed on the inner and outer races. The electrical discharges may also generate vibrations.

In order to overcome these drawbacks, it is known to earth the rotary shaft by using a grounding brush comprising conductive fibers. The grounding brush is generally mounted in the bore of the housing of the electric motor so that the free ends of the fibers are in radial contact with the outer surface of the rotary shaft.

Owing to the conductivity of the fibers, the brush is kept at the same electrical potential as the housing of the electric motor. The inner and outer races of the rolling bearing are also at the same electrical potential, which reduces or eliminates the problematic electrical discharges across the rolling bearing.

US Patent Publication No. 2021/0021180 A1 discloses a grounding brush assembly comprising a grounding brush provided with a plurality of conductive fibers, with a support inside which the conductive fibers are mounted, and with an annular mounting plate comprising a plurality of tabs for radial and axial retention of the support and an annular outer flange radially surrounding the brush and the tabs.

It is also possible to equip the outer surface of the outer race of the rolling bearing with the grounding brush assembly.

With such a solution, however, it may be difficult to mount this assembly between the housing and the rotary shaft of the electric motor.

It is an object of the invention to overcome this drawback.

### SUMMARY OF THE INVENTION

The invention relates to a bearing system comprising a bearing provided with a first race and a second race, which can rotate with respect to one another.

The system also comprises a grounding brush assembly comprising a brush which is offset axially outwards with respect to the inner race of the bearing and is provided with a plurality of conductive fibers and with a support, inside which the conductive fibers are mounted. The conductive fibers preferably project radially inwards with respect to the support.

The grounding brush assembly furthermore comprises a brush mounting plate which is fixed to the support of the brush. The mounting plate comprises a mounting portion arranged partly inside a groove formed in a bore of the outer race of the bearing. The groove is provided with axially opposite first and second side walls, with a base which joins the first and second side walls, and with an internal edge which extends between the second side wall and a front face of the outer race.

According to one general feature, the mounting portion of the mounting plate comprises a radial portion which presses axially against the first side wall of the groove, and at least one first centering portion which continues the radial portion axially outwards and which is radially surrounded by the internal edge of the groove.

According to another general feature, the mounting portion of the mounting plate comprises at least one first flange which continues the first centering portion radially outwards and which presses axially against a front face of the outer race.

According to another general feature, the first centering portion is provided with at least one protuberance which projects in the direction of the base of the groove and which extends radially beyond the internal edge of the groove in order to retain the mounting plate axially relative to the outer race.

This design makes it possible to facilitate the mounting of the system inside the housing of the associated electric motor because the mounting portion of the mounting plate is secured in the groove of the bore of the outer race of the bearing.

The protuberance of the first centering portion of the mounting portion of the mounting plate secures the assembly relative to the outer race of the bearing in a simple and economical way.

Preferably, the radial portion of the mounting portion of the mounting plate is annular. Alternatively, the radial portion may be open at a point on its circumference. In another variant, the radial portion may comprise a plurality of sectors spaced apart from one another in the circumferential direction.

According to one particular design, the mounting portion of the mounting plate comprises a plurality of first centering portions spaced apart from one another in the circumferential direction and a plurality of first flanges, which press axially against the front face of the outer race and each of which continues one of the first centering portions radially outwards. Each first centering portion is provided with at least one protuberance which projects in the direction of the base of the groove and which extends radially beyond the internal edge of the groove.

The mounting portion of the mounting plate may furthermore comprise at least one second centering portion which is spaced apart circumferentially from the first centering portion or from the first centering portions, which continues the radial portion axially outwards and which is surrounded radially by the internal edge of the groove, and at least one second flange which continues the second centering portion radially outwards and which presses axially against the front face of the outer race, the second centering portion being provided with a smooth outer surface.

The mounting portion of the mounting plate may comprise a plurality of second centering portions spaced apart from one another in the circumferential direction and a plurality of second flanges, which press axially against the front face of the outer race and each of which continues one of the second centering portions radially outwards, each second centering portion being provided with a smooth outer surface.

According to another particular design, the first centering portion of the mounting portion of the mounting plate is annular.

In this case, the protuberance of the first centering portion may be annular or may have a shape which is discontinuous in the circumferential direction.

Preferably, the mounting plate is produced in a single piece.

The invention also relates to an electric motor comprising a housing, a shaft and at least one bearing system as defined above, which is mounted radially between the housing and the shaft.

The invention further relates to a method for assembling a bearing system as defined above, comprising the following steps:
before the grounding brush assembly is mounted on the bearing, a step of folding the first flange of the mounting portion of the mounting plate axially on the opposite side from the brush;
a step of axially displacing the grounding brush assembly relative to the bearing in order to make the free end of the folded first flange press axially against the front face of the outer race of the bearing and to make the radial portion press axially against the first side wall of the groove; then
a step of pushing axially against the folded first flange and against the radial portion of the mounting portion of the mounting plate in order to flatten the first flange against the front face of the outer race of the bearing and simultaneously to form the protuberance.

### BRIEF DESCRIPTION OF THE SEVERAL VIEWS OF THE DRAWINGS

The present invention will be understood more clearly by studying the detailed description of an exemplary embodiment, which is taken by way of entirely nonlimiting example and is illustrated with reference to the appended drawings, in which:

FIG. 1 is a perspective view of a bearing system according to one exemplary embodiment of the invention;

FIG. 2 is a front view of the bearing system of FIG. 1;

FIG. 3 is a partial view in section along the axis III-III of FIG. 2;

FIG. 4 is a partial view in section along the axis IV-IV of FIG. 2;

FIG. 5 is a view in section along the axis V-V of FIG. 3;

FIG. 6 is a detail view of FIG. 3;

FIG. 7 is a front perspective view of a grounding brush assembly of the bearing system of FIG. 1 before it is assembled with the bearing of the system;

FIG. 8 is a rear perspective view of a grounding brush assembly of the bearing system of FIG. 1 before it is assembled with the bearing of the system;

FIG. 9 is a partial view in section along the axis III-III of FIG. 2 when the bearing system is being assembled;

FIG. 10 is a partial view in section along the axis IV-IV of FIG. 2 when the bearing system is being assembled;

FIG. 11 is a partial view in section schematically illustrating the mounting of the bearing system of FIG. 1 inside an electrical machine housing;

FIG. 12 is a partial view in section along one section plane of a bearing system according to another exemplary embodiment of the invention;

FIG. 13 is a partial view in section along another section plane of a bearing system according to another exemplary embodiment of the invention;

FIG. 14 is a view in section along the axis XIV-XIV of FIG. 13;

FIG. 15 is a front perspective view of a grounding brush assembly of the bearing system of FIGS. 12 and 13 before it is assembled with the bearing of the system;

FIG. 16 is a rear perspective view of the grounding brush assembly of the bearing system of FIGS. 12 and 13 before it is assembled with the bearing of the system;

FIG. 17 is a partial view in section along a section plane when the bearing system of FIGS. 12 and 13 is being assembled; and

FIG. 18 is a partial view in section along another section plane when the bearing system of FIGS. 12 and 13 is being assembled.

### DETAILED DESCRIPTION OF THE INVENTION

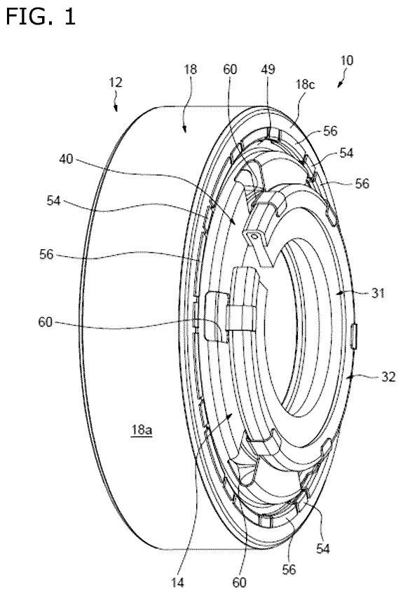

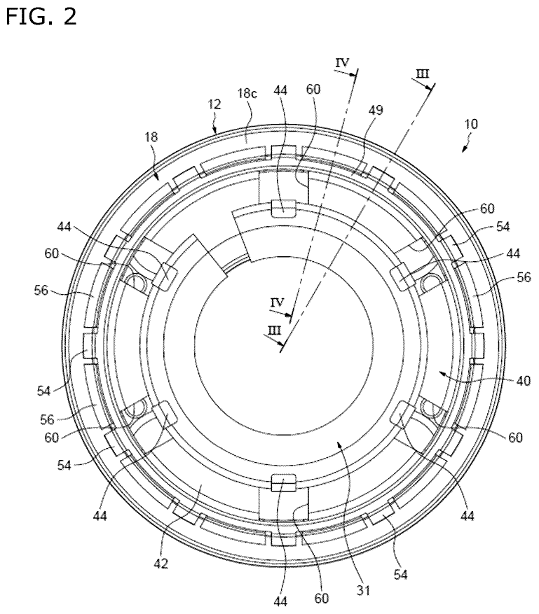

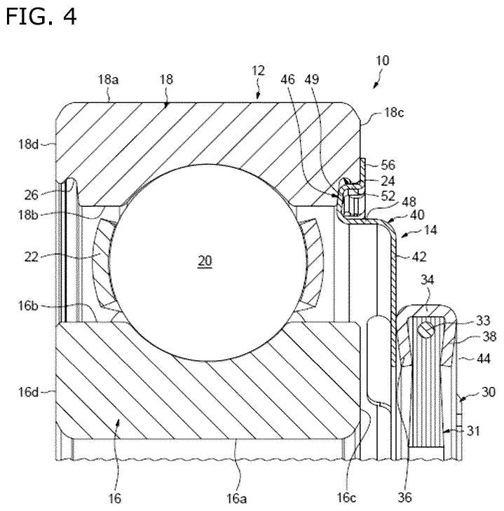

The bearing system illustrated in FIGS. 1 to 4 and referenced 10 overall is intended to be mounted radially between a housing and a rotary shaft of an electric motor or electrical machine.

The bearing system 10 comprises a bearing 12 and a grounding brush assembly 14, which is mounted on the bearing 12.

The bearing 12 is provided with an inner race 16 and with an outer second race 18, which can rotate with respect to one another about the axis (not represented) of the bearing 12. The inner 16 and outer 18 races of the bearing 12 are concentric and extend axially along the axis of the bearing 12. The inner 16 and outer 18 races are made of steel. The races 16, 18 are of the solid type.

In the exemplary embodiment illustrated, the bearing 12 also comprises a row of rolling elements 20, preferably balls but may alternatively be cylindrical rollers, tapered rollers, needles or any other type of rolling element. The rolling elements 20 are interposed radially between the inner and outer races 16, 18. The bearing 12 also comprises a cage 22 for maintaining the regular circumferential spacing of the rolling elements 20.

The inner race 16 includes a cylindrical bore 16a, a cylindrical axial outer surface 16b radially opposite the bore 16a, and radially opposite first and second front faces 16c, 16d which axially delimit the bore 16a and the outer surface 16b. The bore 16a and the outer surface 16b delimit the radial thickness of the inner race 16. The front faces 16c, 16d delimit the axial length of the inner race 16.

The outer race 18 includes a cylindrical axial outer surface 18a, a cylindrical bore 18b radially opposite the outer surface 18a, and radially opposite first and second front faces 18c, 18d which axially delimit the bore 18b and the outer surface 18a. The outer surface 18a and the bore 18b delimit the radial thickness of the outer race 18. The faces 18c, 18d delimit the axial length of the outer race 18.

The outer race 18 further includes first and second annular grooves 24, 26, which are formed on the bore 18b and which extend radially outwardly. Each groove 24, 26 is oriented radially on the side of the inner race 16.

The grooves 24, 26 are arranged axially on either side of the row of rolling elements 20. The groove 24 is located axially in proximity to the front face 18c of the outer race 18, and the groove 26 is located axially in proximity to the front face 18d. The grooves 24, 26 are mutually symmetrical with respect to the radial midplane of the bearing system. Alternatively, the outer race 18 could include only the groove 24.

As will be described in more detail below, the grounding brush assembly 14 is secured in the groove 24 of the outer race 18 of the bearing 12. The assembly 14 has an annular overall shape. The assembly 14 comprises a grounding brush 30 and a brush mounting plate 40, which is configured for radial centering of the brush 30. The mounting plate 40 is secured in the groove 24 of the outer race 18 of the bearing 12.

The brush 30 is offset axially outwardly with respect to the inner race 16 of the bearing 12. In other words, the brush 30 is spaced apart axially from the inner race 16 of the bearing 12. The brush 30 is arranged outside the bearing 12.

The brush 30 comprises a plurality of individual conductive fibers 31, which are intended to enclose the rotary shaft of the motor. The conductive fibers 31 may be made of carbon, stainless steel, conductive plastics such as acrylic fibers, or nylon. The conductive fibers 31 are represented schematically in FIGS. 1, 2, 7 and 8.

The brush 30 furthermore comprises a holding member or support 32, inside which the conductive fibers 31 are mounted. The conductive fibers 31 project radially inwards with respect to the support 32.

In the exemplary embodiment illustrated, the support 32 is in the form of an open ring. The support 32 is made of rigid material. The support 32 may be produced by cutting and swaging. The support 32 is made of electrically conductive material, for example aluminum, stainless steel, bronze, copper or other material. Alternatively, the support 32 may be made of electrically nonconductive material with a conductive coating or a conductive paint.

The brush 30 preferably also comprises a ring 33, around which the conductive fibers 31 are arranged inside the support 32. The ring 33 fulfils a function of supporting the conductive fibers 31. The ring 33 is mounted inside the support 32.

The support 32 of the brush 30 comprises an axial mounting portion 34 and two opposite lateral flanks 36, 38, which extend inwardly from the mounting portion 34 and which axially grip the conductive fibers 31. The conductive fibers 31 press axially on either side against the lateral flanks 36, 38. The conductive fibers 31 press radially against the mounting portion 34. The conductive fibers 31 project radially inwardly with respect to the lateral flanks 36, 38 of the support 32.

The mounting portion 34 and the two lateral flanks 36, 38 delimit a channel, which is open radially on the inner side and inside which the conductive fibers 31 are partly located.

The lateral flank 36 continues one end of the mounting portion 34 and the lateral flank 38 continues its opposite end. The lateral flanks 36, 38 extend obliquely inwardly from the mounting portion 34. The lateral flanks 36, 38 are mutually symmetrical with respect to a radial midplane of the support 32. Alternatively, a single one of the lateral flanks 36, 38 could extend obliquely inwards. In another variant, the two lateral flanks 36, 38 could extend radially. Preferably, the mounting portion 34 extends axially. Alternatively, the mounting portion 34 could extend obliquely.

The brush 30 is in the form of an open ring. This allows the brush 30 to accommodate various diameters of the shaft of the motor. In general, the ends of the brush 30 are not secured to one another. As a variant, it is nevertheless possible to secure these ends of the brush 30 to one another.

The conductive fibers 31 have distal free ends which are intended to come in radial contact with the outer surface of the rotary shaft of the motor. The free ends of the conductive fibers 31 define the inner diameter of the conductive fibers 31, and more generally the inner diameter of the brush 30.

In the exemplary embodiment illustrated, the free ends of the conductive fibers 31 are offset radially inwardly with respect to the bore 16a of the inner race 16 of the bearing 12. In other words, the free ends of the conductive fibers 31 project radially with respect to the bore 16a of the inner race 16. Alternatively, the free ends of the conductive fibers 31 could be radially flush with the bore 16a. In another alternative, the free ends of the conductive fibers 31 could be set back radially with respect to the bore 16a, if the bearing system furthermore comprises a sleeve mounted in the bore 16a of the inner race 16.

The mounting plate 40 of the grounding brush assembly 14 includes an annular radial portion 42 and a plurality of tabs 44 for axial and radial retention of the brush 30, which extend from the radial portion 42.

The mounting plate 40 also comprises a mounting portion 46 arranged partly in the groove 24 of the outer race 18 of the bearing 12, and a connecting portion 48 which joins the mounting portion 46 to the radial portion 42.

The radial portion 42 of the mounting plate 40 presses axially against the support 32 of the brush 30. More precisely, the radial portion 42 presses axially against the lateral flank 36 of the support 32. The radial portion 42 is offset axially outwardly with respect to the inner race 16 of the bearing 12. The radial portion 42 remains axially at a distance from, i.e., spaced from, the front face 16c of the inner race 16. The support 32 of the brush 30 presses axially against the radial portion 42 axially on the opposite side from the inner race 16. Alternatively, depending on the design of the mounting plate 40, the support 32 of the brush 30 may press axially against the radial portion 42 axially on the side of the inner race 16. In this case, the support 32 is arranged axially between the radial portion 42 of the mounting plate 40 and the face 16c of the inner race 16 while remaining spaced apart axially from this face 16c.

The tabs 44 of the mounting plate 40 are spaced apart from one another in the circumferential direction, here regularly or evenly. Alternatively, it could be possible to provide an irregular circumferential spacing. In the exemplary embodiment illustrated, there are six tabs 44. Alternatively, it is possible to provide more or less tabs 44. It is possible to provide two tabs 44 or at least four tabs 44. Preferably, the number of tabs 44 is at least equal to two.

Each tab 44 projects axially with respect to the radial portion 42. Each tab 44 locally surrounds the support 32 of the brush 30 radially and is in radial contact with the mounting portion 34 of the support 32. The tabs 44 keep the support 32 pressed axially against the radial portion 42 of the mounting plate 40. The tabs 44 make it possible to retain the grounding brush 30 axially and radially. The lateral flank 36 of the support 32 presses against the radial portion 42 of the mounting plate 40, and the lateral flank 38 presses against the tabs 44. Preferably, the tabs 44 are mutually identical or identically formed.

Each tab 44 is provided with an axial portion, which extends axially from the radial portion 42, locally surrounds the support 32 radially and is in radial contact with the latter, and with a portion folded radially inwardly, which is provided at the free end of the axial portion. The folded portion of each tab 44 makes it possible to retain the support 32 of the grounding brush 30 axially. The folded portion of each tab 44 is in axial contact against the lateral flank 38 of the support 32.

The connecting portion 48 of the mounting plate is annular and extends axially. The connecting portion 48 extends axially between the large-diameter edge of the radial portion 42 and the inner, small-diameter edge of the mounting portion 46. The mounting portion 46 is offset radially outwardly with respect to the tabs 44 and is offset axially toward the inside of the bearing 12 with respect to the tabs 44.

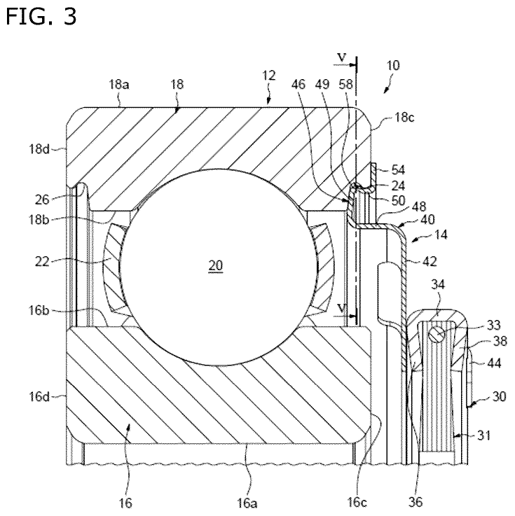

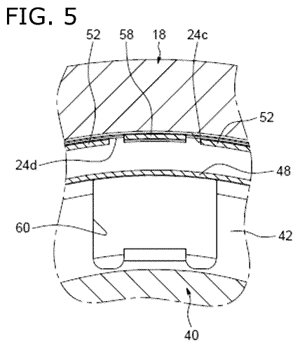

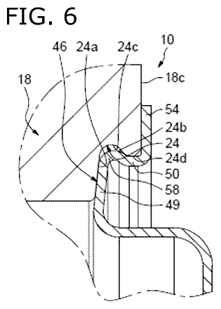

As is illustrated more clearly in FIGS. 3 to 8, the mounting portion 46 of the mounting plate 40 comprises an annular radial portion 49 which projects radially outwardly from the connecting portion 48 of the mounting plate 40. The radial portion 49 is arranged in the groove 24 of the outer race 18 of the bearing 12.

The groove 24 is provided with axially opposite first and second side walls 24a, 24b or flanks. The first and second side walls 24a, 24b are joined by a base 24c, which is oriented radially inwards. Here, the base 24c is concave. Alternatively, the base 24c could have other profiles, for example a flat profile. In another variant, the groove 24 could be formed without a base 24c, in which case the side walls 24a, 24b are joined to one another.

The groove 24 is also provided with an internal edge 24d, which continues the inner, small-diameter end of the second side wall 24b and which is connected to the front face 18c of the outer race 18. The edge 24d extends between the second side wall 24b and the front face 18c, and joins the second side wall 24b and the front face 18c. The edge 24d is offset radially inwards with respect to the base 24c. The groove 24 has a stepped shape. The second side wall 24b has a smaller radial dimension than the first side wall 24a.

The radial portion 49 of the mounting portion 46 of the mounting plate 40 projects radially outwardly from the edge of the connecting portion 48 of the mounting plate 40 which lies axially opposite the radial portion 42. The radial portion 49 is flat. The radial portion 49 presses axially against the first side wall 24a of the groove 24 of the outer race 18 of the bearing 12. There is no axial contact between the radial portion 49 and the second side wall 24b of the groove 24. In other words, the radial portion 49 remains at a distance from the second side wall 24b of the groove 24. The radial portion 49 presses axially against most of the first side wall 24a of the groove.

The mounting portion 46 of the mounting plate 40 comprises a group of first centering portions 50 and a group of second centering portions 52, which extend axially outwardly from the radial portion 49. The first and second centering portions 50, 52 extend axially from the outer, large-diameter edge of the radial portion 49. The first and second centering portions 50, 52 extend axially on the side of the first side wall 24a of the groove of the outer race 18. The first and second centering portions 50, 52 are located within the bore defined by the edge 24d of the groove 24. The first and second centering portions 50, 52 are surrounded radially by the edge 24d of the groove 24. The first and second centering portions 50, 52 jointly or collectively define a circle, which is discontinuous in the circumferential direction and the outer diameter of which, in the free state of the assembly 14 when not mounted on the bearing 12, is less than the inner diameter of the internal edge 24d of the groove 24. The first and second centering portions 50, 52 are generally in the form of lugs.

The first centering portions 50 are spaced apart from one another in the circumferential direction, preferably regularly or evenly. Alternatively, it could be possible to provide an irregular circumferential spacing of the first centering portions 50. In the exemplary embodiment illustrated, there are twelve first centering portions 50. Alternatively, it is possible to provide more or fewer first centering portions 50. It is possible to provide a single first centering portion 50 or at least two or four first centering portions 50. Preferably, the number of first centering portions 50 is at least equal to two.

Similarly, the second centering portions 52 are spaced apart from one another in the circumferential direction, here regularly or evenly. Alternatively, it could be possible to provide an irregular circumferential spacing of the second centering portions 52. In the exemplary embodiment illustrated, there are twelve second centering portions 52. Alternatively, it is possible to provide more or less second centering portions 52. It is possible to provide a single second centering portion 52 or at least two or four second centering portions 52. Preferably, the number of second centering portions 52 is at least equal to two.

In the exemplary embodiment illustrated, each second centering portion 52 is located circumferentially between two successive first centering portions 50. Alternatively, it is possible to provide different relative arrangements of the first and second centering portions 50, 52.

The first centering portions 50 are mutually identical or identically formed. The second centering portions 52 are mutually identical or identically formed. The axial dimension of the first centering portions 50 is equal to the axial dimension of the second centering portions 52. The circumferential dimension of the first centering portions 50 is less than the circumferential dimension of the second centering portions 52. Alternatively, the circumferential dimension of the first centering portions 50 could be equal to or greater than the circumferential dimension of the second centering portions 52. In another variant, the first centering portions 50 could have different circumferential dimensions from one another. Alternatively or additionally, the second centering portions 52 could also have different circumferential dimensions from one another.

The mounting portion 46 of the mounting plate 40 also includes a group of first flanges 54 and a group of second flanges 56, which respectively continue or extend radially outwardly from the first centering portions 50 and the second centering portions 52. In other words, the first flanges 54 extend radially outwardly from the first centering portions 50 and the second flanges 56 extend radially outwardly from the second centering portions 52.

Each first flange 54 extends from the end of the associated first centering portion 50, which is located axially opposite the radial portion 49. Each first flange 54 has a circumferential dimension equal to the circumferential dimension of the associated first centering portion 50. Each first flange 54 is pressed axially against the front face 18c of the outer race 18. Each first flange 54 remains set back or offset radially with respect to the outer surface 18a of the outer race 18.

Similarly, each second flange 56 extends from the end of the associated second centering portion 52, which is located axially opposite the radial portion 49. Each second flange 56 has a circumferential dimension equal to the circumferential dimension of the associated second centering portion 52. Each second flange 56 is pressed axially against the front face 18c of the outer race 18. Each second flange 56 remains set back radially with respect to the outer surface 18a of the outer race 18.

Each first centering portion 50 of the mounting portion 46 of the mounting plate 40 is provided with a protuberance 58 which projects radially outwardly in the direction of the base 24c of the groove 24. The protuberance 58 of each first centering portion 50 projects radially. Each protuberance 58 is formed over at least part of the length of the associated centering portion 50. Each protuberance 58 may be formed over the entire circumferential dimension of the associated centering portion 50. The protuberance 58 of each first centering portion 50 is connected to the radial portion 49 of the mounting portion 46 of the mounting plate 40. The protuberances 58 are mutually identical or identically formed.

Each first centering portion 50 has a constant thickness, including in the region of the associated protuberance 58. As will be described in more detail below, each protuberance 58 is obtained by local material deformation of the associated first centering portion 50.

Each protuberance 58 presses axially against the second side wall 24b. Each protuberance 58 extends radially beyond, or outwardly from, the internal edge 24d of the groove 24. In other words, each protuberance 58 projects radially toward the base 24c of the groove 24 with respect to the internal edge 24d of the groove 24.

Each protuberance 58 retains the mounting plate 40 axially relative to the outer race 18. The axial retention of the mounting plate 40 relative to the outer race 18 is ensured by diametral interference between the protuberances 58 and the second side wall 24b of the groove 24. The protuberances 58 form a collar, which is discontinuous in the circumferential direction and the outer diameter of which is greater than the inner diameter of the internal edge 24d of the groove 24.

Each first centering portion 50 of the mounting portion 46 of the mounting plate is provided with a smooth outer surface. A “smooth outer surface” means that the outer surface of each first centering portion 50 has no projection or protuberance and is essentially flat.

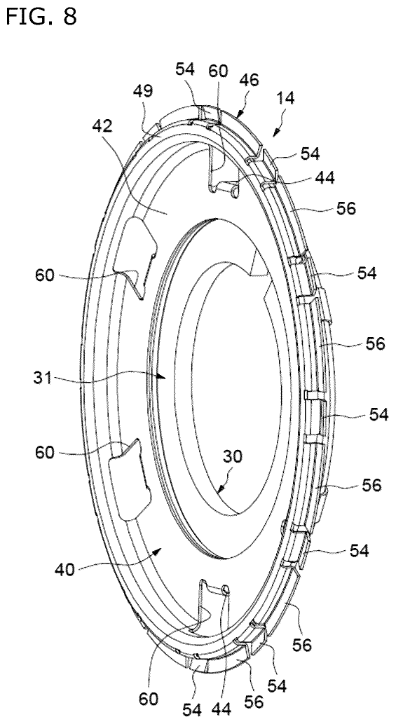

A plurality of through-openings 60 are made in the thickness of the radial portion 42 and of the connecting portion 48 of the mounting plate 40. The openings 60 are formed during the partial cutting of the mounting plate 40 in order to form the tabs 44. The tabs 44 are formed by cutting, folding and crimping the mounting plate 40. The openings 60 are spaced apart from one another in the circumferential direction. Each tab 44 is aligned in the circumferential direction with the associated opening 60. The number of openings 60 corresponds to the number of tabs 44. As may be seen in FIG. 8, the root of each tab 44 extends from an internal edge of the associated opening 60, which is located on the radial portion 42.

The mounting plate 40 is produced by cutting and swaging. The mounting plate 40 is made of electrically conductive material, for example aluminum, stainless steel, bronze, copper or other material. Alternatively, the mounting plate 40 may be made of electrically nonconductive material with a conductive coating or a conductive paint. Preferably, the mounting plate 40 is produced in a single piece.

In order to assemble the bearing system 10, the following procedure is adopted.

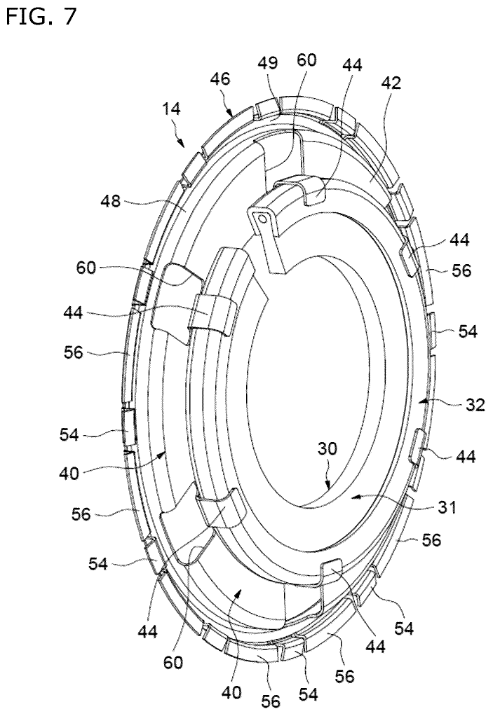

In a first step, after or during the manufacture of the grounding brush assembly 14 and before it is mounted on the bearing 12, the flanges 54 of the mounting portion 46 of the mounting plate 40 are deformed by folding axially on the opposite side from the brush 30, as is illustrated in FIGS. 7 and 8.

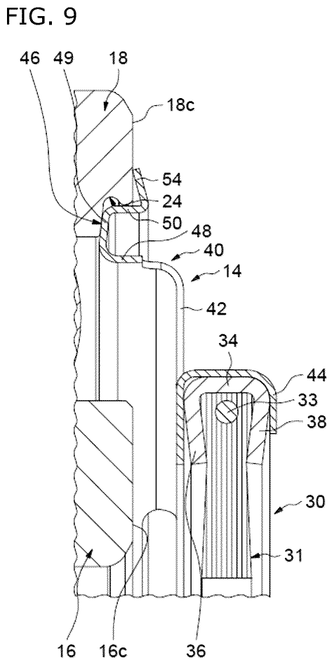

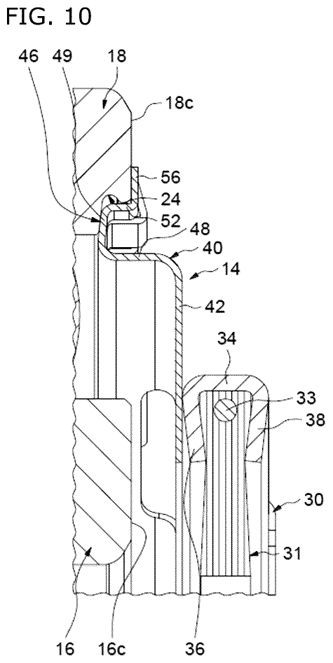

Subsequently, in a second step, the grounding brush assembly 14 is displaced axially relative to the bearing 12 in order to make the folded flanges 54 and the flanges 56 press axially against the front face 18c of the outer race and to make the radial portion 49 of the mounting portion 46 of the mounting plate 40 press axially against the side wall 24a of the groove 24, as is illustrated in FIGS. 9 and 10. The first and second centering portions 50, 52 of the mounting portion 46 of the mounting plate 40 do not interfere with the internal edge 24d of the groove 24 during this relative displacement.

Finally, in a third and last step, an axial force is applied to the flanges 54 and to the radial portion 49 of the mounting portion 46 of the mounting plate 40 in order to flatten the flanges 54 against the front face 18c of the outer race 18 and simultaneously to form the protuberances 58. The protuberances 58 are thus formed by local material deformation of the first centering portions 50. The deformed parts of the first centering portions 50 partly fill the groove 24 of the outer race 18 and form the protuberances 58. The protuberances 58 are obtained or formed by local plastic deformations of the first centering portions 50 of the mounting plate 40.

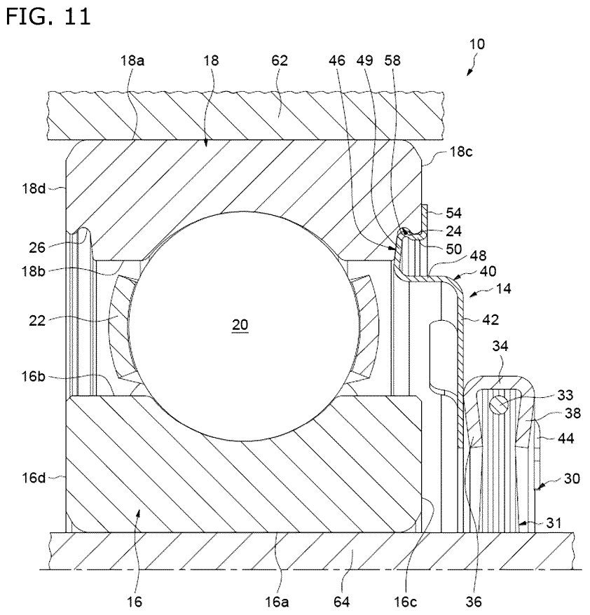

As is illustrated in FIG. 11, the brush system 10 may be mounted inside the bore of the housing 62 of the associated electric motor and on the rotary shaft 64 of the motor. The bearing 12 is mounted radially between the bore of the housing 62 and the rotary shaft 64 of the motor.

During operation of the electric motor, the electrical charges which accumulate on the shaft 64 are dissipated to the housing 62 through the conductive fibers 31, the support 32 of the brush 30 and the mounting plate 40 of the assembly 14.

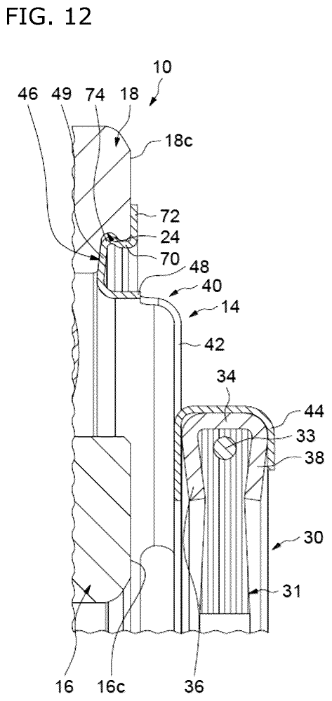

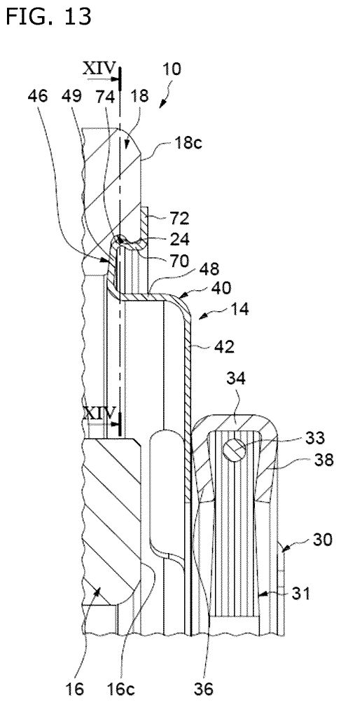

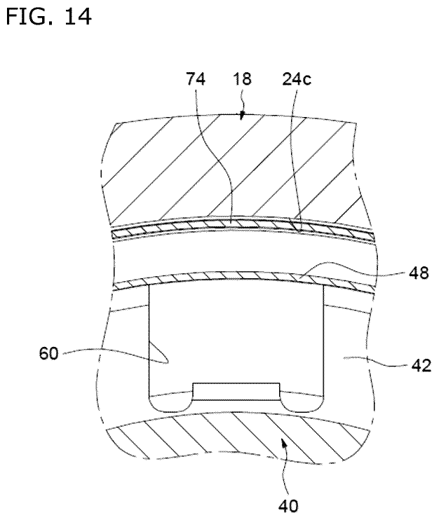

The exemplary embodiment illustrated in FIGS. 12 to 16, in which identical elements have the same references, differs from the previous example principally in that the mounting portion 46 of the mounting plate comprises an annular centering portion 70 instead of the first and second centering portions.

The centering portion 70 extends axially outwardly from the radial portion 49. The centering portion 70 extends axially from the outer, large-diameter edge of the radial portion 49. The centering portion 70 is located in the bore defined by the edge 24d of the groove. The centering portion 70 is surrounded radially by the edge 24d of the groove. The outer diameter of the centering portion 70 is less than the inner diameter of the internal edge 24d of the groove in the free state of the assembly 14 when not mounted on the bearing 12.

In this example, the mounting portion 46 of the mounting plate also comprises an annular flange 72 which continues the centering portion 70 radially outwards. The flange 72 continues the end of the centering portion 70 which is located axially opposite the radial portion 49. The flange 72 is pressed axially against the front face 18c of the outer race. The flange 72 remains set back radially with respect to the outer surface 18a of the outer race.

The centering portion 70 is provided with an annular protuberance 74 projecting outwards in the direction of the base 24c of the groove. The protuberance 74 projects radially. The protuberance 74 is connected to the radial portion 49 of the mounting portion of the mounting plate.

The centering portion 70 has a constant thickness, including in the region of the protuberance 74. The protuberance 74 is obtained by local material deformation of the centering portion 70.

The protuberance 74 presses axially against the second side wall 24b. The protuberance 74 extends radially beyond the internal edge 24d of the groove. In other words, the protuberance 74 projects radially towards the base 24c of the groove with respect to the internal edge 24d of the groove.

The protuberance 74 retains the mounting plate 40 axially relative to the outer race 18. The axial retention of the mounting plate 40 relative to the outer race 18 is ensured by diametral interference between the protuberance 74 and the second side wall 24b of the groove. The protuberance 74 forms a collar, which is continuous in the circumferential direction and the outer diameter of which is greater than the inner diameter of the internal edge 24d of the groove.

In order to assemble the bearing system 10, the following procedure is adopted.

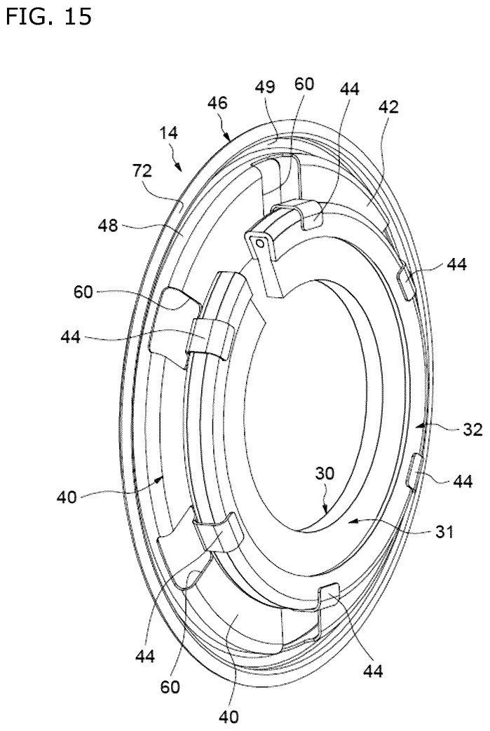

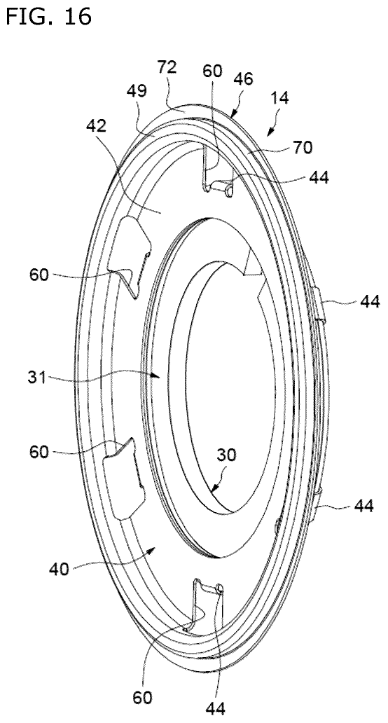

In a first step, after or during the manufacture of the grounding brush assembly 14 and before it is mounted on the bearing 12, the flange 72 of the mounting portion of the mounting plate is deformed by folding axially on the opposite side from the brush 30, as is illustrated in FIGS. 15 and 16.

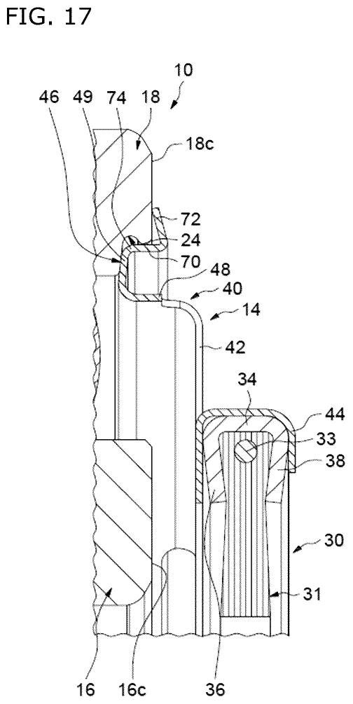

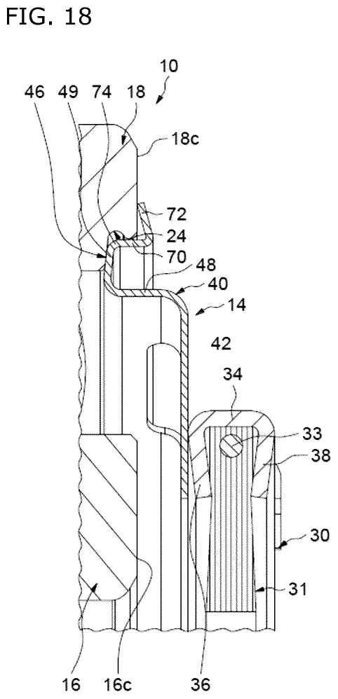

Subsequently, in a second step, the grounding brush assembly 14 is displaced axially relative to the bearing 12 in order to make the folded flange 72 press axially against the front face 18c of the outer race and to make the radial portion 49 of the mounting portion of the mounting plate press axially against the side wall 24a of the groove, as is illustrated in FIGS. 17 and 18. The centering portion 70 of the mounting portion of the mounting plate does not interfere with the internal edge 24d of the groove during this relative displacement.

Finally, in a third and last step, an axial force is applied to the flange 72 and to the radial portion 49 of the mounting portion of the mounting plate in order to flatten the flange 72 against the front face 18c of the outer race and simultaneously to form the protuberance 74. The protuberance 74 is thus formed by local material deformation of the centering portion 70. The deformed part of the centering portion 70 partly fills the groove 24 of the outer race and forms the protuberance 74. The protuberance 74 is obtained by local plastic deformation of the centering portion 70 of the mounting plate.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A bearing system comprising:
a bearing including an inner race and an outer race, at least one of the inner and outer races being rotatable relative to the other one of the inner and outer races, the outer race having a bore and a groove formed in the bore, the bore having axially opposite first and second side walls, a base which joins the first and second side walls, and an internal edge extending between the second side wall and a front face of the outer race; and
a grounding brush assembly including a brush offset axially outwardly with respect to the inner race of the bearing, the brush having a support and a plurality of conductive fibers disposed within the support, and a brush mounting plate fixed to the support of the brush and having a mounting portion arranged partly inside the groove of the outer race of the bearing, the mounting portion including a radial portion pressed axially against the first side wall of the groove, at least one first centering portion extending axially outwardly from the radial portion and radially surrounded by the internal edge of the groove, and at least one first flange extending radially outwardly from the at least one first centering portion and pressed axially against the front face of the outer race, the first centering portion having at least one protuberance projecting toward the base of the groove and extending radially beyond the internal edge of the groove so as to retain the mounting plate axially relative to the outer race.

2. The system according to claim 1, wherein the radial portion of the mounting portion of the mounting plate is annular.

3. The system according to claim 1, wherein the mounting portion of the mounting plate includes a plurality of first centering portions spaced circumferentially apart from each other and a plurality of first flanges, each one of the plurality of first flanges pressing axially against the front face of the outer race and extending radially outwardly from a separate one of the first centering portions, each first centering portion having at least one protuberance projecting toward the base of the groove and radially beyond the internal edge of the groove.

4. The system according to claim 1, wherein the mounting portion of the mounting plate further includes at least one second centering portion spaced circumferentially apart from the at least one first centering portion or extending from the at least one first centering portion, the at least one second centering portion extending axially outwardly from the radial portion and being radially surrounded by the internal edge of the groove, and at least one second flange extending radially outwardly from the second centering portion and pressing axially against the front face of the outer race, the second centering portion having a smooth outer surface.

5. The system according to claim 4, wherein the mounting portion of the mounting plate includes a plurality of second centering portions spaced circumferentially apart from each other and a plurality of second flanges, each one of the plurality of second flanges pressing axially against the front face of the outer race and extending radially outwardly from a separate one of the plurality of second centering portions, each second centering portion having a smooth outer surface.

6. The system according to claim 1, wherein the at least one first centering portion of the mounting portion of the mounting plate is annular.

7. The system according to claim 6, wherein the at least one protuberance of the at least one first centering portion is annular.

8. An electric motor comprising:
a housing;
a shaft; and
at least one bearing system according to claim 1 mounted radially between the housing and the shaft.

9. A method for assembling a bearing system according to any claim 1, the method comprising the steps of:
before the grounding brush assembly is mounted on the bearing, folding the at least one first flange of the mounting portion of the mounting plate axially on an opposite side of the brush;
axially displacing the grounding brush assembly relative to the bearing so as to press a free end of the folded first flange axially against the front face of the outer race of the bearing and to press the radial portion of the mounting portion axially against the first side wall of the groove; and
pushing axially against the at least one folded first flange and against the radial portion of the mounting portion of the mounting plate in order to flatten the at least one first flange against the front face of the outer race of the bearing and to simultaneously form the at least one protuberance.
